(19) United States
(12) Patent Application Publication
(10) Pub. No.: US 2008/0098637 A1
(43) Pub. Date: May 1, 2008

(54) Labeling system for pipes and valves

(76) Inventor: Dwight A. Pratt, Rockford, MI (US)

Correspondence Address: Donald W. Meeker;Patent Agent, 924 East Ocean Front #E, Newport Beach, CA, 92661, US

(21) Appl. No.: 11/973,254

(22) Filed: Oct. 4, 2007

Related U.S. Application Data
(60) Provisional application No. 60/851,229, filed on Oct. 12, 2006.

(51) Int. Cl. G09F 3/10

(52) U.S. Cl. 40/673

(57) ABSTRACT

A simple, inexpensive labeling system for building conduit systems has a series of color-coded identifier tags that identify pipes, tubes, conduits, and the handles of various shutoff or control valves. Necessary emergency repair numbers, advertising, and an area for additional hand-written information may be provided. The identifier tags are die cut from durable, water resistant plastic and are of a sufficient thickness to provide rigidity to hang securely on pipes from a center hole and V-notch connected by a split. The user slips the identifier tag over the pipe by opening the notch and secures it by letting the notch close itself around the pipe.

### CROSS-REFERENCE TO RELATED APPLICATIONS

The present utility patent application claims the benefit of provisional application No. 60/851,229 filed Oct. 12, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to the field of identification and marking of plumbing and wiring conduits and in particular to a simple and inexpensive labeling system for pipe, tube or conduit and on the handles of various shutoff or control valves, the system comprising identifier tags die cut from durable, water resistant plastic material with sufficient thickness to provide rigidity to hang properly and securely on the pipes or valves while being thin enough to allow for simple handling and installation using a hole die cut in each identifier tag slightly larger than the pipe to which it to be affixed and located near the top of the identifier tag with a triangular notch from the hole to the edge above which opens wide enough to allow the identifier tag to be easily slipped around the pipe and once in place, the notch closes, holding the identifier tag in place around the pipe or the stem of handles of most common valves, thereby saving valuable time in tracing the source or destination of the pipes and valves using indicia which may be both imprinted and written on the identifier tags.

2. Description of Related Art Including Information Disclosed Under 37 CFR 1.97 and 1.98

Labeling of many types of pipes and valves is not required by national or local codes or standards. A simple method of tagging and identifying those pipes and valves offers many advantages including ease of tracing pipes for purposes of maintenance and repair work. This not only simplifies the work, but potentially prevents serious damage that could be caused by delays in locating lines and valves leading to existing leaks.

The prior art does not provide tags easily affixed which are rigid enough to remain flat for viewing in a hanging position until removed and resilient enough to be easily applied with both imprinted and written information on the tags.

U.S. Patent Application #20070068226, published Mar. 29, 2007 by Karamanos, provides a method for controlling quality and tracking parts for repair and replacement in a piping system, including a valve and a piping structure coupled to the valve. The method comprises the following: pressurize the piping structure with a gas at greater than sea-level pressure; seal the gas in the piping structure with the valve; determine whether the gas stays within the piping structure; determine that gas leaks from the piping structure; and identify the location of a leak from the piping structure. The invention further comprises a method for identifying a component. The method comprises the following: indicate identification information on a tag regarding the piping structure; and attach the tag to the piping structure.

U.S. Patent Application #20020089173, published Jul. 11, 2002 by Reidy, shows a pipe or other conduit identification labeling system comprising a kit having at least one identification tag for identifying an individual pipe or conduit, a pipe cleaner, and an adhesive bonding agent for adhering the identification tag to the pipe. The kit also includes appropriate directions on how the identification tag can be properly adhered to a pipe or other conduit. The identification tag comprises a one-piece rigid substrate body having raised indicia for identifying an individual pipe located on an upper flat surface, and arcuately shaped lower surface for permitting the lower surface of the identification tag to matingly attach to the corresponding outer surface of the pipe or other conduit by the application of the adhesive bonding agent applied to the lower surface prior to placement of the identification on the pipe. The identification tag can be used to label a variety of pipes and conduits, particularly 1½″ and 2″ PVC pipes used in the plumbing systems of swimming pools and spa.

U.S. Patent Application #20020032102, published Mar. 14, 2002 by Boire, is for a labeler for pipes, conduits, tubes, and rods which includes a saddle leg having an inside diameter equal to or slightly smaller than an outside diameter of a pipe or conduit to be labeled. The saddle leg is molded to a saddle stem which in turn is molded to a sign plate. A user either writes useful information directly on the sign plate or affixes a pre-made label to the plate. The sign plate optionally includes raised lettering or information such as an arrow pre-molded on the plate, or Braille characters. The labeler resiliently clips onto the pipe or conduit being labeled. More complex variations of the labeler include extending arms and moveable joints, enabling the identification of pipes or conduits which are at difficult angles or out of direct sight of a user. The labeler provides a means for quickly and clearly labeling pipes, conduit, tubes, and rods. The labeler can be mass produced as a single mold or in parts with different sign plates of varying size and construction. The sign plate provides a flat surface for writing. The labeler can be temporary, removable, or made permanent simply by applying an adhesive to the saddle portion prior to affixing the labeler.

U.S. Pat. No. 7,194,829, issued Mar. 27, 2007 to Boire, claims a pipe or conduit labeler includes a saddle leg having an inside diameter equal to or slightly smaller than an outside diameter of a pipe or conduit to be labeled. The saddle leg is molded to a saddle stem which in turn is molded to a sign plate. A user either writes useful information directly on the sign plate or affixes a pre-made label to the plate. The sign plate optionally includes raised lettering or information such as an arrow pre-molded on the plate; or Braille characters. The labeler resiliently clips onto the pipe or conduit being labeled. More complex variations of the labeler include extending arms and movable joins, enabling the identification of pipes or conduits which are at difficult angles or out of direct sight of a user. The labeler allows for quickly and clearly labeling pipes, conduit, tubes, and rods. The labeler can be mass produced as a single mold or in parts with different sign plates of varying size and construction. The sign plate provides a flat surface for writing. The labeler can be temporary, removable, or made permanent simply by applying an adhesive to the saddle portion prior to affixing the labeler.

U.S. Pat. No. 7,140,236, issued Nov. 28, 2006 to Karamanos, provides a method and system for controlling quality and tracking parts for repair and replacement in a piping system, including a valve and a piping structure coupled to the valve. The method comprises the following: pressurize the piping structure with a gas at greater than sea-level pressure; seal the gas in the piping structure with the valve; determine whether the gas stays within the piping structure; determine that gas leaks from the piping structure; and identify the location of a leak from the piping structure. The invention further comprises a method for identifying a component. The method comprises the following: indicate identification information on a tag regarding the piping structure; and attach the tag to the piping structure.

Two U.S. patents, U.S. Pat. No. 6,845,581 issued Jan. 25, 2005 and U.S. Pat. No. 6,267,152 issued Jul. 31, 2001 to Doerr, are for a hang tag and method of applying hang tag to an elongated object. The hang tag is preferably relatively planar and includes a slot therein which serves as an opening for a securement strap (e.g., a cable tie) to be threaded therethrough.

Two U.S. patents, U.S. Pat. No. 3,270,872 and U.S. Pat. No. 3,270,873 issued Sep. 6, 1966 to Paxton, are for bag closure clips with labels.

U.S. Pat. No. D329,468, issued Sep. 15, 1992 to Hatt, is for the ornamental design for a combined advertising sign and business card for hanging on a door knob.

U.S. Pat. No. D306,043, issued Feb. 13, 1990 to Hickmott, shows the ornamental design for a plant tag.

U.S. Pat. No. D413,356, issued Aug. 31, 1999 to Ingram, provides the ornamental design for a sleeping baby doorknob sign.

U.S. Pat. No. 2,188,710, issued Jan. 30, 1940 to Giovanini, describes a pipeline identification device which comprises a narrow elongated strip which is color-coded and encircles the pipe.

U.S. Pat. No. 5,311,688, issued May 17, 1994 to Aeschbacher, discloses a pipe marker which consists of an elongated sign, which has a front face for bearing identifying information and a rear face with a bracket-receiving channel, and at least one bracket that can be attached to a pipe with strapping. The bracket includes a ratchet for tightening the strapping and an outward projection containing a compression spring which snaps into the bracket-receiving channel of the sign.

U.S. Pat. No. 5,402,592, issued Apr. 4, 1995 to Caveney, indicates an embossed pipe marker for conforming display around an elongate object having a longitudinal axis includes a planar information display surface of sufficient flexibility to conform to the shape of the elongate object, a plurality of embossments in the information display surface arranged to display an informational symbol field, wherein longer peripheral edges of each of the embossments are aligned parallel to an embossment alignment direction, and a fastener for securing the marker around the elongate object in a desired display orientation of the informational symbol field such that the embossment alignment direction is substantially parallel to the longitudinal axis of the elongate object whereby the flexibility of the planar information display surface is not degraded by the embossments.

U.S. Pat. No. 4,246,712, issued Jan. 27, 1981 to Vander Wall, puts forth a pipe identification system which includes a marker fabricated from a rigid material and having indicia imprinted thereon providing information on the pipe contents. Flow direction markers are removably secured and integral with opposite ends of the contents marker. Each flow direction marker has indicia thereon indicating flow direction. One or both of the flow direction markers may be separated from the contents marker prior to attachment of the marker to a pipe. One or more straps engage the markers for attaching the markers to a pipe.

U.S. Pat. No. 6,183,016, issued Feb. 6, 2001 to Parker, concerns a labeling insulation tape that combines a conventional insulation tape with pipe identification markings or lettering. According to one embodiment, the identification markings are repeatedly printed onto the tape in a continuous form fashion creating on the tape a series of individual label sections. Conventional printing techniques are used in the printing of the tape. The labeling insulation tape is then cut and rolled into convenient-to-use lengths. Alternate embodiments include the tape being cut into lengths equal to individual labels and a long roll of peel-off backing with a multiplicity of individual label releasably adhered thereto.

U.S. Pat. No. 5,129,985, issued Jul. 14, 1992 to Crowley, illustrates a tube label applicator comprising a tool which is adapted to removably engage a rolled semi-rigid, plastic label, retaining the label in an open orientation to facilitate placement of the label on a pipe. In the preferred embodiment, the tool includes an elongated handle connected to and extending outwardly from the bottom side of a base plate. A plurality of support posts attach to and extend outwardly from the top side of the base plate, and support a pair of label racks proximate the free ends of the support posts. Each of the label racks has at least one label engaging flange disposed on one side thereof. The label racks are disposed apart from one another on the support posts in an opposed, inwardly facing manner. The label engaging flanges are thus disposed in an opposed, inwardly facing surface to releasably engage opposite edges of a rolled plastic label and releasably retain the rolled plastic label in an opened configuration for placement on the pipe. This tool is typically disposed on an extension section or bar to place labels on pipes which are a distance from the user.

U.S. Pat. No. 5,138,784, issued Aug. 18, 1992 to Niwa, describes a pipe identification system using marking collars which indicate the contents of a pipe and/or the direction of fluid flow. The pipe contents may be indicated by the color of the marking collar or by symbols marked on the collar. Fluid flow direction may be indicated by arrows which may be raised and colored a different color to the base of the marking collar. The marking collars may be easily attached or removed and are suitable for rapidly marking pipes during a hazard situation.

U.S. Pat. No. D309,159, issued Jul. 10, 1990 to Hickmott, indicates the ornamental design for a plant tag.

U.S. Pat. No. 4,430,816, issued Feb. 14, 1984 to Seton, illustrates a marker system for pipes or valves comprising a tape having a surface layer and a pressure sensitive adhesive layer, the tape defining spaced-apart transparent window areas. A release paper backing is deployed on the adhesive layer of the tape, and the release paper backing includes pre-cut window backing portions generally registered with the transparent window areas of the tape. The pre-cut window backing portions may be joined with the release paper backing along a hinge/tear line whereby the window backing portions may be folded away from the tape. The marker system further comprises information cards sized to be adhered in the transparent window areas of the tape. The marker system is installed by first removing or folding back the pre-cut window backing portions of the release paper backing and adhering the information cards in the window area. The marker system may be installed by thereafter removing the remainder of the backing paper as the tape is wrapped around the pipe for marking the pipe or an adjacent valve; however, in marker systems where the window backing portions are hinged to the remainder of the release paper backing, the window backing portions may be positioned over the information cards, covering any exposed adhesive, and the marker system may be rolled up for storage or shipment prior to installation. In one embodiment, the release paper backing is provided in segments with alternate segments providing the window backing portions. The marker system is cut to length for installation around a pipe with the cuts being made through a blank segment of the release paper backing, so that the portions of release paper backing adjacent the ends may be removed for adhering the length of marker system to a pipe.

U.S. Pat. No. 1,764,102, issued Jun. 17, 1930 to Hudler, provides a memorandum card made in the form of an annular, card-like clip that may be applied to an element of a vehicle instrument board and on which notations may be made.

What is needed are identifier tags providing a simple and inexpensive labeling system for pipe, tube or conduit and on the handles of various shutoff or control valves, which can save valuable time in tracing the source or destination of those pipes and valves, the identifier tags having a unique structure and functional details including a durable flat moderately thick sheet of flexible memory plastic which has a circular opening with a center top split and V-shaped open edge which opens to admit the identifier tag inserted to encircle the pipe or valve with the split closing to its original shape to close the circle over the top of the pipe or valve and having printed information and written information on the flat identifier tag which remains on the pipe or valve until removed.

### BRIEF SUMMARY OF THE INVENTION

An object of the present invention is to provide a simple and inexpensive identifier tag labeling system for pipe, tube or conduit and on the handles of various shutoff or control valves, which can save valuable time in tracing the source or destination of those pipes and valves, the identifier tags having a unique structure and functional details including a durable flat moderately thick sheet of flexible memory plastic which has a circular opening with a center top split and V-shaped open edge which opens to admit the identifier tag inserted to encircle the pipe or valve with the split closing to its original shape to close the circle over the top of the pipe or valve and having printed information and written information on the flat identifier tag which remains on the pipe or valve until removed.

Another object of the present invention is to provide easily identified color coded identifier tags for hot and cold supplies in a building conduit system.

One more object of the present invention is to provide an area for phone numbers to be printed or written on the identifier tags that can be called in emergency situations and a means for advertising tradesmen who install or repair systems.

In brief, a simple and inexpensive labeling system for building conduit networks including pipes, tubes, conduits and the handles of various shutoff or control valves comprises identifier tags die cut from durable, water resistant plastic material with sufficient thickness to provide rigidity to hang properly and securely on the pipes or valves while being thin enough to allow for simple handling and installation. A circular opening die cut in each identifier tag is slightly larger than the pipe to which it is to be affixed and located near the top of the identifier tag. A split in the circular opening and a triangular notch from the circular opening to the top edge opens wide enough to allow the identifier tag to be easily slipped around the pipe or conduit or valve and once in place, the notch closes, holding the identifier tag securely in place around the pipe or the stem of handles of most common valves until removed, thereby saving valuable time in tracing the source or destination of the pipes and valves using indicia which may be both imprinted and written on the identifier tags.

An advantage of the present invention is that it provides a simple and inexpensive labeling system for pipes, tubes, conduits, and the handles of various shutoff or control valves for an entire building conduit network, which can save valuable time in tracing the source or destination and function of all elements of the building conduit systems.

Another advantage of the present invention is to provide easily installed identifier tags with sufficiently holding strength to keep the identifier tag in place securely in ordinary applications.

One more advantage of the present invention is that identifier tags are color coded for quick and easy identification of hot and cold water supplies.

An additional advantage of the present invention is providing quick and easy access to phone numbers printed or written on the identifier tags that can be called in emergency situations.

A further advantage of the present invention is that the identifier tags provide instant, multiple references to the tradesman throughout the end user's home or business for many years whenever plumbing work may be needed via the imprinted information area on the identifier tags. The identifier tag is also a valuable advertising medium for tradesmen who would place them on pipes and valves whenever they would be performing installations or repairs.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a front elevational view of one of the identifier tags of the labeling system of the present invention showing the imprinted information, hand written information, and the circular opening, top notch, and top split for applying the label to a cylindrical conduit;

FIG. 2 is a perspective view of the identifier tag of the labeling system of FIG. 1 showing the thickness of the tag;

FIG. 3 is a perspective view of the identifier tag of FIG. 1 applied to a horizontal cylindrical conduit element;

FIG. 4 is a perspective view of a series of identifier tags of the present invention applied to a series of vertical cylindrical conduit elements;

FIG. 5 is a front elevational view of a pair of identifier tags of the present invention applied to two valves of the building conduit system;

FIG. 6 is a front elevational view of one of the color coded identifier tags of the labeling system of the present invention showing the imprinted “HOT” identifier on the red color coded identifier tag, a blank white space for hand written information, and the circular opening, top notch, and top split for applying the label to a cylindrical conduit;

FIG. 7 is a front elevational view of another of the color coded identifier tags of the labeling system of the present invention showing the imprinted “COLD” identifier on the blue color coded identifier tag, a blank white space for hand written information, and the circular opening, top notch, and top split for applying the label to a cylindrical conduit.

### DETAILED DESCRIPTION OF THE INVENTION

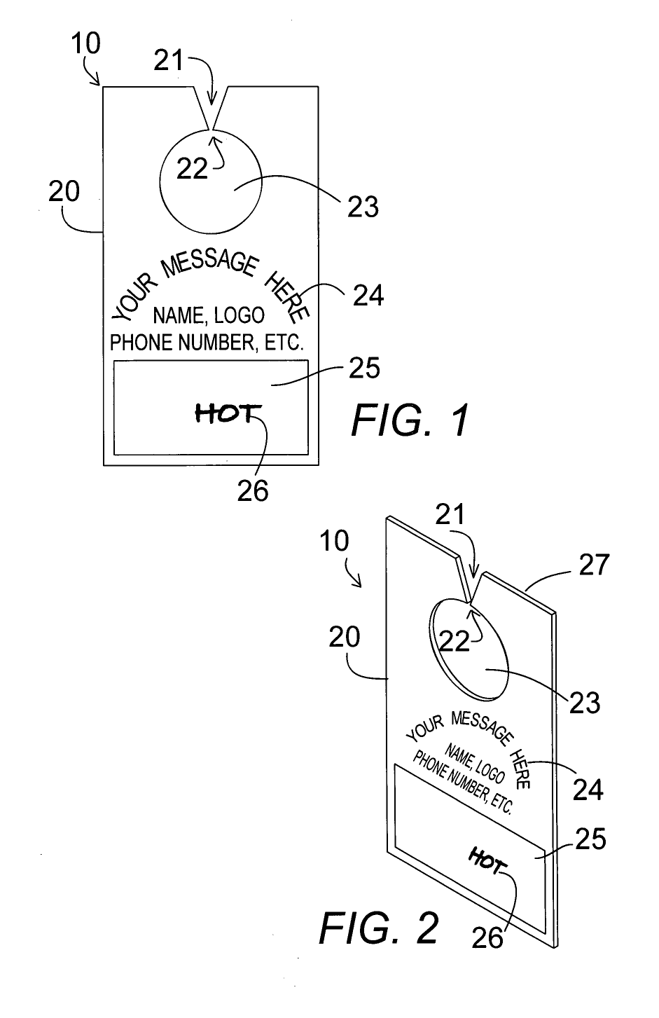

In FIGS. 1-7, a labeling system 10 for building conduit systems having networks of pipes, tubes, conduits, valves, and other cylindrical elements with different functions connected to a variety of locations within a building comprises a series of identifier tags 20, 20A and 20B.

The series of identifier tags 20, 20A and 20B each comprises a vertical sheet of permanent flexible memory plastic with a horizontally centered circular opening 23 adjacent to the top edge of the sheet, and a horizontally centered V-shaped open notch 21 in the top edge. The V-shaped open notch communicates with the circular opening via a center top split 22 between the circular opening and the V-shaped open notch enabling it to spread apart to encircle a cylindrical element, with the split closing to its original shape once around the cylindrical element. The circular opening 23 is larger in diameter than a cylindrical element of a building conduit system to which the identifier tag is attached. Each of the identifier tags further comprises a function indication area having a flat printable surface containing imprinted information 24 and a flat write-on surface 25 for hand written information 26 to serve for labeling the cylindrical element with an indication of the nature and function of the cylindrical element, the location to which the cylindrical element connects within a building conduit system having networks of pipes, tubes, conduits, valves and other cylindrical elements, and to distinguish on the flat identifier tag how the labeled cylindrical element relates to the other cylindrical elements of the building conduit systems. Each of the identifier tags are designed to remain on the cylindrical element until removed, the series of identifier tags thereby providing a consistent means for easily identifying all of the cylindrical elements of the building conduit systems.

Each of the identifier tags is die cut out of durable, water resistant, plastic material with sufficient thickness to provide rigidity to hang flat and securely on the cylindrical element, while being sufficiently flexible to allow for simple handling and installation.

Each of the identifier tags may have imprinting on a back surface 27 or the back surface left blank.

Each of the identifier tags also has a space for advertising information 24 on the front and a space for emergency phone numbers 26 on the front to call relative to the maintenance of the building conduit systems, with the back surface 27 also available for such information.

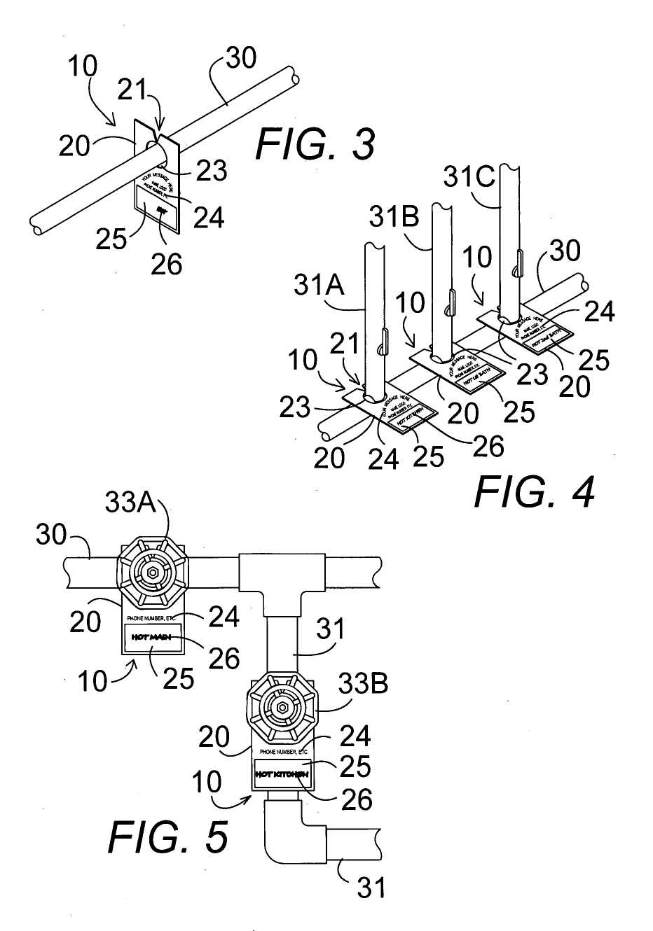

In FIG. 3, an identifier tag 20 is applied to a horizontal cylindrical conduit element 30.

In FIG. 4, a series of identifier tags 20 are applied to a series of vertical cylindrical conduit elements 31A, 31B, and 31C.

In FIG. 5, a pair of identifier tags are applied to two valves 33A and 33B of the building conduit system.

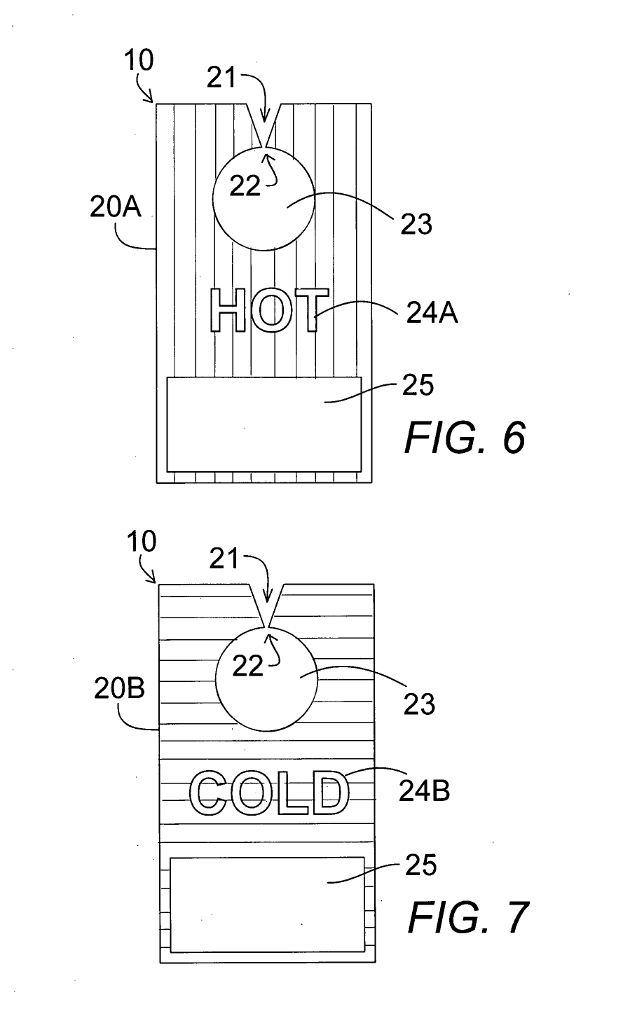

In FIGS. 6 and 7, each of the identifier tags may be color coded according to the type of cylindrical element to which it is attached. An identifier tag intended for use on cylindrical elements supplying hot water and hot steam may be printed on red colored material, as in the red identifier tag 20A with the word “HOT” 24A imprinted in waterproof white ink, as in FIG. 6. Likewise, an identifier tag intended for use on cylindrical elements supplying cold water is printed on blue colored material, as in the blue identifier tag 20B imprinted with the word “COLD” 24B in waterproof white ink, as in FIG. 7. A flat white write-on surface 25 is provided on each identifier tag for hand written information. The user may write the destination of that particular pipe or valve or other useful information, using any permanent, waterproof marking pen.

In use, a hole 23 in each identifier tag, slightly larger than the pipe to which it to be affixed, is located near the top of the identifier tag. A triangular notch 21 above communicating with the hole 23 via a slit 22, opens wide enough to allow the identifier tag to be easily slipped around the pipe. Once in place, the notch closes into its normal position, holding the identifier tag securely in place around the pipe.

The hole and notch design also allows the identifier tag to be easily hung around the stem of handles of most common valves, identifying the valves as well as the pipes. This configuration and the use of appropriate material permit easy installation of the tag and enough security to keep the tag in place in ordinary applications.

Some identifier tags may also be imprinted with various specific room destinations in addition to the white block. Those identifier tags allow the user to more easily tag the pipe or valve with very specific destination information such as the exact fixture in a specific room that is supplied by that pipe or valve.

In addition, the identifier tag allows enough space on the face and on the reverse side to permit the printing of additional information such as the name, logo, phone number, etc., of a plumbing contractor, other tradesman, etc.

This makes the identifier tags more valuable to the user by providing quick and easy access to phone numbers that can be called in emergency situations.

It also makes the identifier tag a valuable advertising medium for tradesmen who would place them on pipes and valves whenever they would be performing installations or repairs. The identifier tags would provide instant, multiple references to the tradesman throughout the end user's home or business for many years whenever plumbing work may be needed.

It is understood that the preceding description is given merely by way of illustration and not in limitation of the invention and that various modifications may be made thereto without departing from the spirit of the invention as claimed.

What is claimed is:

1. A labeling system for building conduit systems having networks of pipes, tubes, conduits, valves, and other cylindrical elements with different functions connected to a variety of locations within a building, the system comprising:
a series of identifier tags each comprising a vertical sheet of permanent flexible memory plastic having a horizontally centered circular opening adjacent to a top edge of the sheet, the circular opening larger in diameter than a cylindrical element of a building conduit system to which the identifier tag is attached, each of the series of identifier tags having a horizontally centered V-shaped open notch in the top edge communicating with the circular opening via a center top split in the circular opening between the circular opening and the V-shaped open notch so that the notch and circular opening spread apart to encircle the cylindrical element with the split closing to its original shape around the cylindrical element to close the circle over the top of the cylindrical element, each of the tags further comprising a function indication area having a flat printable surface containing imprinted information and a flat write-on surface containing hand written information to label the cylindrical element with an indication of the nature and function of the cylindrical element and the location to which the cylindrical element connects within a building conduit system having networks of pipes, tubes, conduits, valves and other cylindrical elements to distinguish on the flat identifier tag how the labeled cylindrical element relates to the other cylindrical elements of the building conduit system, each of the identifier tags remaining on the cylindrical element until removed, the series of identifier tags thereby providing a consistent means for identifying all of the cylindrical elements of the building conduit system.

2. The system of claim 1 wherein each of the identifier tags is die cut out of durable, water resistant plastic material with sufficient thickness to provide rigidity to hang flat and securely on the cylindrical element while being sufficiently flexible to allow for simple handling and installation.

3. The system of claim 1 wherein each of the identifier tags is color coded according to the type of cylindrical element to which it is attached.

4. The system of claim 3 wherein an identifier tag intended for use on cylindrical elements supplying hot water and hot steam are printed on red colored material.

5. The system of claim 3 wherein an identifier tag intended for use on cylindrical elements supplying cold water is printed on blue colored material.

6. The system of claim 1 wherein each of the identifier tags further comprises a back imprint surface for providing additional information.

7. The system of claim 1 wherein each of the identifier tags further comprises a space for advertising information.

8. The system of claim 1 wherein each of the identifier tags further comprises a space for emergency phone numbers to call relative to the maintenance of the building conduit systems.
